(19) United States
(12) Patent Application Publication
(10) Pub. No.: US 2022/0092669 A1
(43) Pub. Date: Mar. 24, 2022

(54) Dynamic Cannabis Delivery Platform

(71) Applicant: Pyrotree, Inc., Los Angeles, CA (US)

(72) Inventors: Hilart Abrahamian, Van Nuys, CA (US); Christopher Dell olio, Santa Clarita, CA (US)

(21) Appl. No.: 17/028,867

(22) Filed: Sep. 22, 2020

(51) Int. Cl. G06Q 30/06; G06Q 10/08; G06Q 30/00

(52) U.S. Cl. CPC G06Q 30/0631; G06Q 30/0641; G06Q 30/018; G06Q 10/083

(57) ABSTRACT

The present invention relates to an ecommerce online store front and management system for legal cannabis businesses. The system enables building cannabis product ecommerce store fronts either for a collection of products fulfilled by a number of cannabis retailers (i.e. a 3^{rd} party ecommerce instance) or a set of products fulfilled by a specific cannabis retailer. The platform enables efficient delivery by overlaying the delivery area of multiple retailers over a specific user location to provide multiple options for delivery, including products in stock in a delivery vehicle.

The ecommerce store front also updates dynamically to display only products available to a specific user based on a variety of criteria including delivery address, cannabis retailer and delivery driver. The store front has the ability to update dynamically when the user places a product in the shopping cart, based on the assigned retailer or delivery driver. The ecommerce platform integrates with state, Federal or national cannabis regulatory authority “track and trace” systems. Unique product tracking IDs are captured and sent to central repositories via APIs.

### BACKGROUND OF THE INVENTION

### Field of the Invention

The disclosed invention relates to systems and methods for managing the ordering and delivery of cannabis products by licensed cannabis retailers who offer delivery of their goods. While ecommerce platforms and product delivery are well known in the art, the disclosed invention's novel approach to providing a dynamically updating online store, the most efficient delivery path based on in-vehicle inventory and automated regulatory compliance make it unique in the art.

Legalized cannabis is a rapidly growing industry in many states in the US and in other foreign countries. Cannabis customers have come to expect a wide selection of products, online ordering and rapid delivery. State and national regulatory authorities have implemented detailed structures for tracking and tracing cannabis products from the grow, packaging, manufacture, distribution and ultimate sale to a third party. States such as California provide unique IDs for each product so that cannabis inventory can be tracked at every stage of the product life cycle.

Current cannabis delivery platforms either offer a collection of unaffiliated cannabis retailers, some licensed, and some not with little guidance for which retailers can deliver to a specific user location. Other platforms offer delivery but do not update their online store with available products for delivery to the user's specific location. Current platforms do not enable offering a collection of specific products with the functionality of fulfilling delivery by specific retailers. Existing technology solutions do not provide for efficient and rapid delivery by providing an in-vehicle inventory model. Current online ecommerce platforms in the cannabis space also do not currently integrate seamlessly with state regulatory authorities and systems.

### Description of the Background Art

Ecommerce shopping and delivery systems are well known in the art, but existing platforms have limitations that make their use in the legal cannabis market challenging. Prior references disclose ordering systems that optimize shipping vendors for a delivery address, display a dynamic product catalog, couriers with product in stock in their delivery vehicle and APIs connected to third parties for data transfer.

None of the prior art platforms or references allow a user to select from a menu of products and then have that menu update dynamically 1) by what is available for delivery to their address, 2) what is available for delivery to their address by a specific retailer, and/or 3) products available in a specific delivery driver's vehicle for rapid delivery. Additionally, integration with state cannabis regulatory authority data tracking systems is also unavailable in prior art platforms. These are the problems to be solved by the present invention.

### Objects of the Invention

It is an object of the invention to provide an ecommerce and delivery optimization platform for the legal cannabis industry.

It is an object of the invention to provide a dynamic ecommerce store front enabling a collection of cannabis products fulfilled by multiple cannabis retailers.

It is an object of the invention to provide a dynamic ecommerce store front displaying only cannabis goods available for delivery to a specific user location.

It is an object of the invention to provide a dynamically updating ecommerce store front displaying only cannabis products available for delivery by a specific cannabis retailer.

It is an object of the invention to provide to provide a dynamically updating cannabis ecommerce store front showing only products available for delivery by a specific delivery driver.

It is an object of the invention to provide a dynamically updating cannabis ecommerce store front that shows only products available for purchase based on a combination of retailer, delivery address and delivery driver.

It is an object of the invention to create cannabis product orders containing a SKU and a state tracking ID for the product.

It is an object of the invention to provide a cannabis ecommerce platform that is integrated with state cannabis authority tracking systems.

It is an object of the invention to provide a cannabis ecommerce platform that integrates with the California track and trace system METRC.

### SUMMARY OF THE INVENTION

The present invention relates to an ecommerce online store front and management system for legal cannabis businesses. The system enables building cannabis product ecommerce store fronts either for a collection of products fulfilled by a number of cannabis retailers (i.e. a 3^{rd} party ecommerce instance) or a set of products fulfilled by a specific cannabis retailer. The platform enables efficient delivery by overlaying the delivery area of multiple retailers over a specific user location to provide multiple options for delivery, including a novel in-vehicle inventory model.

The ecommerce store front also updates dynamically to display only products available to a specific user based on a variety of criteria including delivery address, cannabis retailer and delivery driver. The store front has the ability to update dynamically when the user places a product in the shopping cart, based on the assigned retailer or delivery driver. This dynamically updating store front allows the user to select only products that are available to them at their delivery address, by the selected retailer or that are in stock in the delivery driver's vehicle.

The ecommerce platform integrates with state, Federal or national cannabis regulatory authority “track and trace” systems. Unique product tracking IDs are captured and sent to central repositories via APIs.

### BRIEF DESCRIPTION OF THE DRAWINGS

FIG. 1 shows a block diagram of the complete dynamic delivery platform.

FIG. 2 shows a block diagram of the platform front end.

FIG. 3 shows a block diagram of the customer and employee accounts functions.

FIG. 4 shows a block diagram of the location services function.

FIG. 5 shows a block diagram of the regulatory compliance function.

FIG. 6 shows a block diagram of a 3^{rd} party ecommerce instance.

FIG. 7 shows a flow chart of the customer order flow for a 3^{rd} party ecommerce instance.

FIG. 8 shows a block diagram of a retailer instance.

FIG. 9 shows a retailer instance with expanded driver instances displayed.

FIG. 10 shows a flow chart of the customer order flow for a retailer.

FIG. 11 shows a block diagram of the dynamic delivery platform system.

### DESCRIPTION OF THE PREFERRED EMBODIMENT

The disclosed invention, preferred embodiments and claims relate to a novel dynamic ecommerce cannabis delivery platform. The platform offers a unique and novel approach to ordering and delivering legal cannabis products. Either 3^{rd} party ecommerce cannabis businesses or licensed cannabis retailers can build online shopping experiences with this platform and due to the dynamic nature of the products displayed, customers are allowed to select only products that are available for delivery to them, or delivery to them by existing delivery drivers. Additionally, customers can be offered additional products that are in a delivery driver's vehicle for easy delivery. The dynamic nature of the system allows the products available for selection by the customer to updated in real time based on the previous goods selected, the delivery address, delivery driver and other key criteria. While the detailed description below describes the features of the preferred embodiments known at the time of filing the application, other embodiments consistent with the claims are anticipated.

The preferred embodiment of the disclosed system is built in Node.js and React but the claimed invention could be built using any number of front and back end coding technologies well known in the art such as HTML, Javascript, Java, Python, Ruby on Rails, and many others.

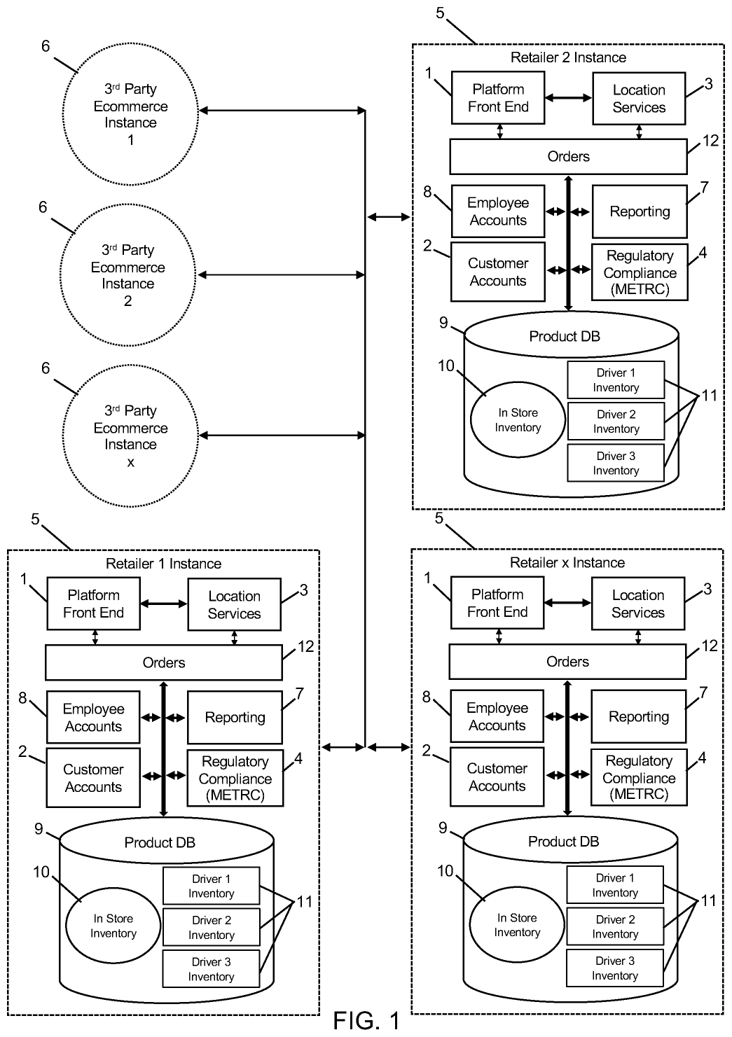

FIG. 1 shows a block diagram of the disclosed Dynamic Delivery Platform with the major functional units displayed. Each of these functions will be described in summary here with more detailed discussion of each unit later in the specification. Platform front-end 1 contains the functionality required to build and display the ecommerce functionality of the platform on desktop computer websites, mobile applications and mobile websites. This functional block broadly includes the product and pricing databases, shopping cart and check out functionality required to allow customers to shop for, select and purchase products. The block also includes the items necessary for each of the 3^{rd} party ecommerce instances and retailers to build their ecommerce front ends for display on websites, mobile apps and mobile web and to display a menu of available products. The block further includes point-of-sale (POS) functionality utilized by retailers to complete transactions not completed through the ecommerce functions. Customer Accounts 2 contains a centralized repository of all the customer account data for end users of the platform. This includes name, delivery address, email, phone, identification, username and password. This code block contains all the required logic, functionality and databases to setup, login to and verify a customer account. Similarly employee accounts 8 includes all the data for the verified employees that utilize the platform to complete sales and contains similar functionality to the customer accounts 2 block.

Location services 3 allows provides location data for customers to determine delivery area and retailers available for that location. This code block allows overlay GPS data, browser location data and/or delivery address on retailer delivery areas to match customers with available retailers in their area.

Regulatory Compliance block 4 enables interface with the state provided regulatory frameworks required for legal cannabis businesses. Most states that have legalized cannabis require some form of tracking cannabis production, distribution, sales and delivery. These tracking systems are typically called “Track and Trace.” For example, the State of California has implemented METRC as its track and trace system. This code block includes the required interface to send data to the regulatory authorities and to store the required track and trace data.

Reporting block 7 provides a variety of reporting capabilities including but not limited to sales reports, profit reports, inventory reports, employee sales reports, product aging, driver cash reports, state compliance reports and a variety of other reports that are useful for managing a cannabis business.

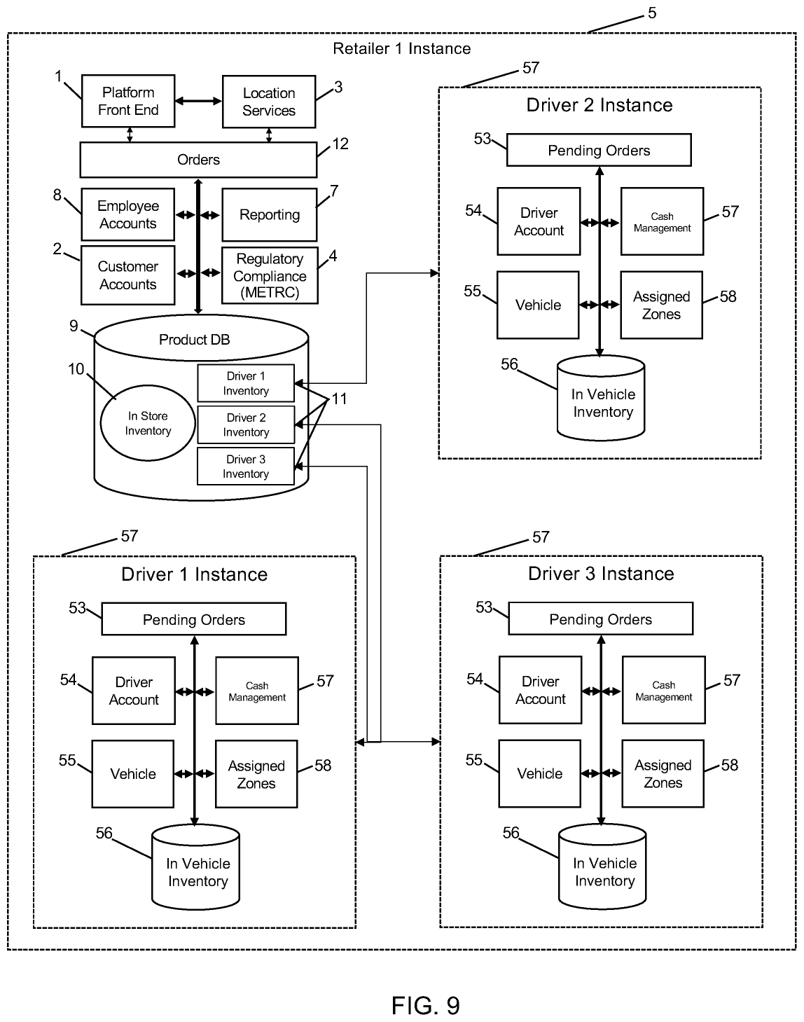

Product DB 9 contains much of the core functionality of the present invention. The product DB 9 stores all inventory available for delivery comprising of products located in In Store Inventory 10 and various Driver Inventory 11. More details of this key functionality are shown in FIG. 9.

3^{rd} Party Ecommerce Instance 6 represent the cannabis 3^{rd} party ecommerce instances enabled by the dynamic delivery platform. For purposes of this patent application, the term 3^{rd} party ecommerce instance means a cannabis seller that curates one or more products from one or more cannabis brands, and offers them for sale, but orders are actually fulfilled by a local licensed cannabis retailer and/or delivery service. This means that a 3^{rd} party ecommerce instance could collect a variety of products and offer them for sale state wide (or an even wider geographic area if allowed by state and Federal laws) but fulfill the order through a local licensed retailer who has the product in stock and can deliver it to the customer quickly. The platform can support any number of 3^{rd} party ecommerce instances 6, here represented by instances 1, 2 and through x.

Retailer instance 5 represents a licensed cannabis retailer or delivery service that accepts orders directly and fulfills them directly. These retailers typically have a limited geographic delivery area, as set by regulation, or just the limits of profitability. As with 3^{rd} party ecommerce instances, the platform can support any number of retailer instances 5, here represented by instances 1, 2 and through y.

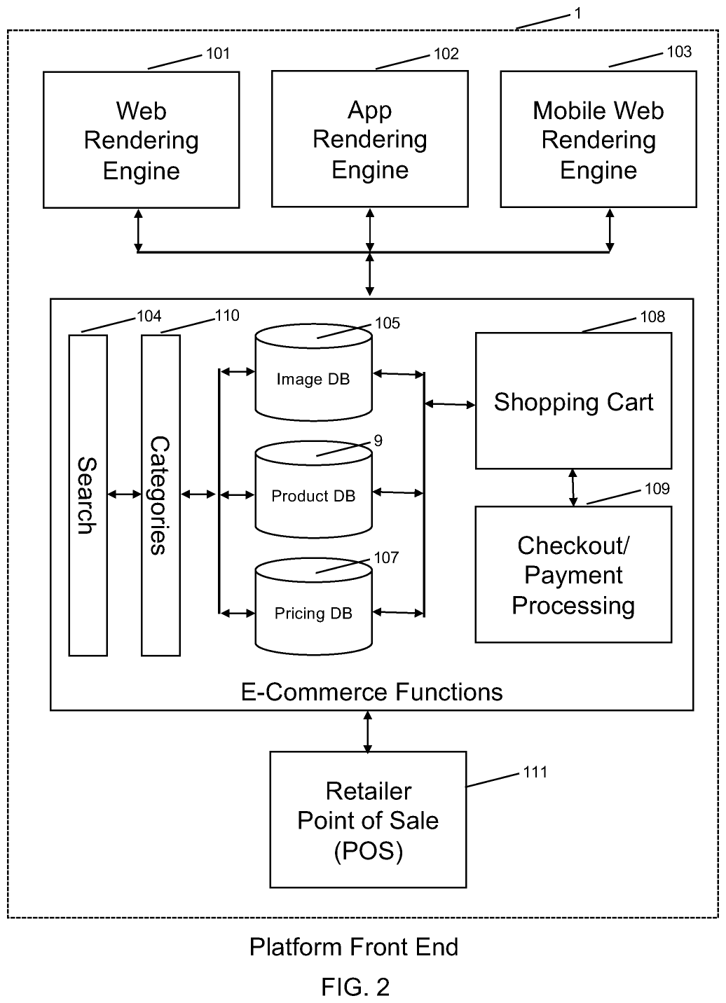

FIG. 2 is a detailed view of the Platform Front End with its included functions. Web Rendering Engine 101 includes the required code and logic to display the platform's front end on typical desktop web browsers such as Chrome, Firefox, Safari and Microsoft Edge. This block contains the HTML, HTML5 and CSS code to assure that the ecommerce portion of the platform displays correctly. Further, this block contains a variety of store themes that can be selected for the ecommerce store functionality. These pre-defined themes allow retailers or 3rd party ecommerce instances to have turn-key build and operation of their platform instances. App Rendering Engine 102 includes similar functionality to Web Rendering Engine 101 but supporting mobile device applications such as those for Apple iPhone and Google Android devices. These same rendering capabilities and themes are available. Lastly, the Mobile Web Rendering Engine provides front end rendering capabilities for mobile web browsers such as Safari for iPhone, the Android native browser and Chrome for iPhone/Android.

The various rendering engines are connected to the ecommerce functions that support the basic functions of the online stores enabled by the platform. These functions include displaying the menu of available products for sale, searching for the products by category or using search functionality, placing products in a shopping cart and allowing customer check out. As will be discussed later in this description, the shopping cart functionality disclosed here is novel in that the products available for purchase update dynamically based on what products a customer places in their cart.

Search block 104 allows freeform or text search of the various products for sale on the platform. This sort of text or key word search is well known in the art and is combined with product categories 110 that allow review of available products by product category. These categories could include, but are not limited to, flower, pre-rolls, accessories, vape pens, vape cartridges, edibles (by category) and other common items offered for sale in legal cannabis businesses. Search 104 and Categories 110 are connected to Image DB (database) 105, Product DB 9 and Pricing DB 107. These databases are set up using Amazon Aurora PostgreSQLon Amazon Web Services (AWS) but could be built using any database technology well known in the art. Image DB 105 contains the product images for each of the products offered for sale in a given 3^{rd} party ecommerce or retailer instance. This could include a variety of sizes and angles as needed to support various web and mobile page layouts. The Image DB also includes required metadata for each of the product images such as title, size, manufacturer and other data as needed for the system.

Product DB 9 includes details about each product offered for sale in a given 3^{rd} party ecommerce instance or retailer instance online store. This database includes information such as product manufacture, title, description, and regulatory compliance information. Product DB 9 also includes details about in-store inventory and specific driver inventory as will be seen in detail in later figures. Other data that may be useful for other embodiments is anticipated by the claims and could be included as necessary for the design of the platform. Pricing DB 107 includes pricing and discount information for all the products offered for sale by a given 3^{rd} party ecommerce instance or retailer. Each of these databases, Image DB 105, Product DB 9 and Pricing DB 107 are connected directly to the 3^{rd} party ecommerce or retailer instance and display only the menu of products, including images and pricing for that particular instance.

Shopping Cart 108 is connected directly to the search, categories and databases. When a customer selects a product from the menu for purchase, that product is placed in this virtual shopping cart. In one of the novel elements of this disclosed platform, as a customer places items in their shopping cart, the remaining products available for purchase update dynamically based on the item selected to for the cart. The items can be narrowed by a selected retailer or by a selected driver and what stock that driver has in their car.

Once a customer finalizes their items in shopping cart 108, Checkout/Payment processing functions in 109 facilitate the purchase. This includes processing credit cards and other electronic purchase methods such as Paypal, Venmo, or Apple Pay and others well known in the art, providing receipts and delivery tracking. In addition, each purchase must be passed to the Regulatory Compliance functions for tracking and tracing as required by state regulatory authorities.

Retailer point of sale (POS) 111 is typical point of sale functionality located physically at the retailer location and is used for completing any transactions that come in over the phone or in person at the location, or any transaction not completed through the ecommerce functions. This POS 111 function includes standard point of sale functionality including payments through electronic, credit card and cash means, split payments, returns, refunds and store credits, connection to the various inventory databases including product db 9, inventory reports, sales reports, connection to customer accounts 2 and connection to employee accounts 8

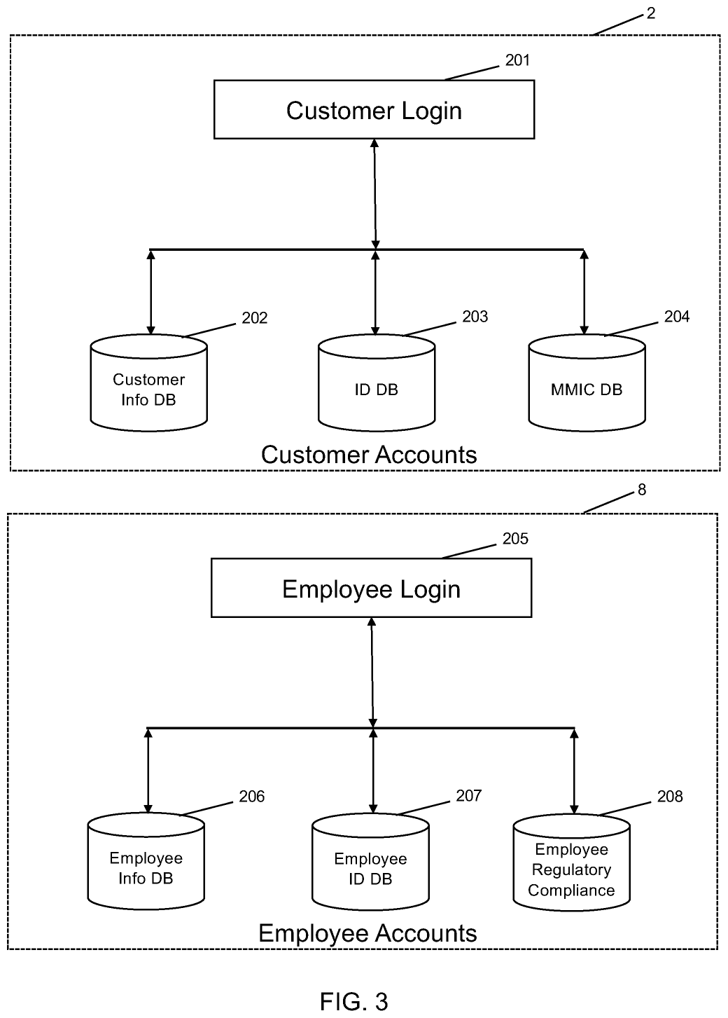

FIG. 3 displays the requisite components of the Customer Accounts 2 and Employee Accounts 8 functionality of the disclosed invention. Here Customer Login block 201 allows a user to login in with existing credentials or to create a new account. While the platform can be used to build and provide front end and back end support for any number of 3^{rd} party ecommerce or retailer instances, each appearing to be its own independent online presence, users can create a single account that can be utilized over any 3^{rd} party ecommerce or retailer instance. The Customer Information Database 202 stores key customer information like username, password, email address, mobile phone number, delivery address, billing address, stored payment methods, previous order history and other important customer details. ID Database 203 stores images and information about the customer's state driver's license or identification. This stored ID information is used to verify that the customer is of legal age to purchase cannabis products, which are available only to those over 21 in most states. The MMIC Database stores information about Medical Marijuana Information Cards in states or jurisdictions that allow them. Inclusion of MMIC data for a customer can impact pricing and tax rates for purchased products.

Employee accounts 8 functions very similarly to customer accounts 2 and includes employee login 205, which is connected to employee info DB 206, employee ID DB 207 and employee regulatory compliance 208. Employee login 205 stores the login details for each verified employee of a 3^{rd} party ecommerce or retail instance. Employee ID DB 207 stores required information about the employee's driver's license or state ID, as required by regulatory authorities. Employee regulatory compliance 208 stores all required regulatory compliance details for a given employee, including sales and other information. This block connects to regulatory compliance 4 for transmittal of all required information to the regulatory authorities. In the preferred embodiment, such data is transmitted to METRC, the California State track and trace database.

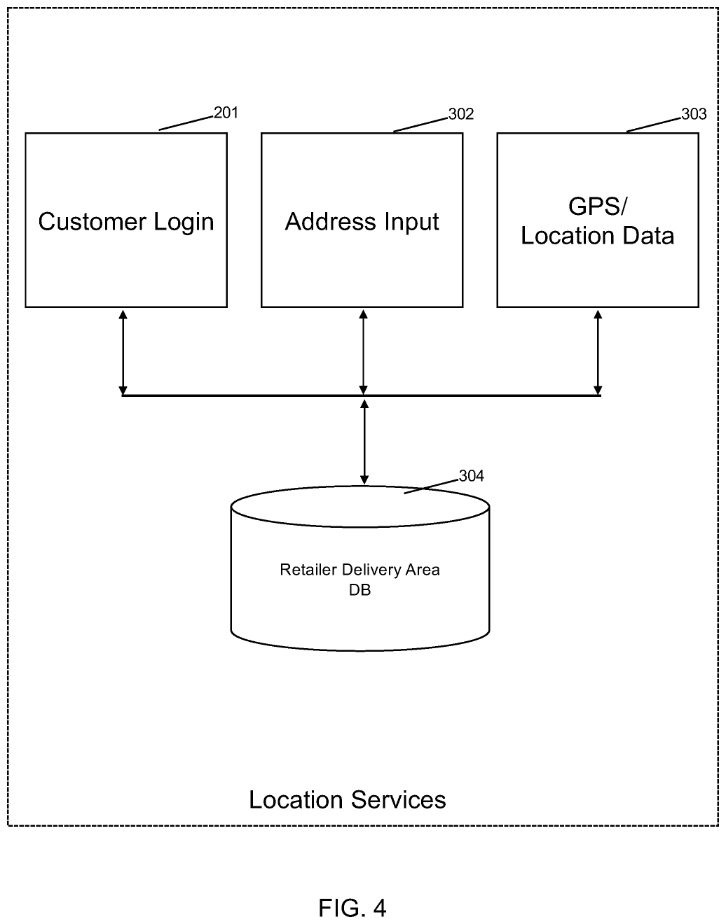

FIG. 4 provides detail about the Location Services functionality for the disclosed dynamic delivery platform. Here customer login 201 is connected to the customer login functionality in the Customer Accounts section of the platform. By logging in, the platform then has access to location data for the given customer, specifically delivery address for their order. If the customer does not have an account or login, then the customer must either enter the provide their delivery address in the Address Input 302 section or provide access to GPS/Location Data in 303. Address Input section 302 takes address input and normalizes it so it can be overlaid on the Retailer Delivery Area DB to match with delivery services that offer deliver to the customer's address. Further, upon providing permission access to either GPS (Global Positioning System) data on their device or browser location data for GPS/Location Data 303 block, the system then translates this data into a delivery address that can be similarly overlaid on the Retailer Delivery Address DB to match available delivery services.

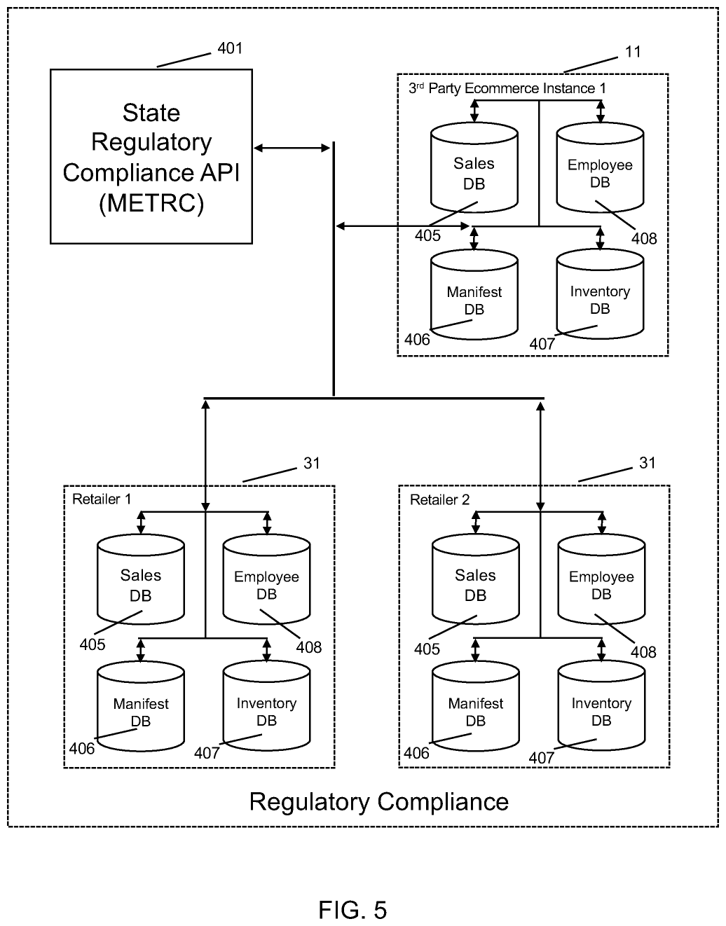

FIG. 5 is an expanded view of the Regulatory Compliance Block 4. State Regulatory Compliance API 401 is an application programming interface (API) for transferring information to and from the state regulatory compliance system. As well known in the art, APIs are typically used to transfer structured data from one computer system to another. In the preferred embodiment, the state regulatory compliance system is for the State of California. California uses a system titled METRC but it's anticipated that the disclosed invention could be used with any state, Federal or other country's regulatory compliance systems.

3^{rd} Party Ecommerce Instance 1 regulatory compliance block 11 contains databases of all the required regulatory compliance information. The California based preferred embodiment, METRC, requires sales information as stored in Sales DB 405, employee information as stored in Employee DB 408, manifest information as stored in Manifest DB and inventory information as stored in Inventory DB 407. As the California METRC “track and trace” system tracks every cannabis product starting with its grow, packaging, distribution and ultimately sale to the end user, the Sales DB 405 tracks any sale of a particular cannabis good tracked in the METRC system. Each cannabis product sold has a stock keeping unit (SKU) assigned by the retailer and a unique ID tag number specific to that product. The unique ID tag number is used to track that specific cannabis product.

Employee DB 408 stores all relevant employee data for licensed cannabis businesses, including but not limited to names, addresses and related sales information. Manifest DB 406 stores information related to cannabis products ordered from licensed distributors by licensed retailers or delivery services for sale to the end consumer. The Manifest DB 406 as implemented in the California METRC system includes a package UID (universal ID) as well as the quantity of products ordered. Lastly, Inventory DB 407 stores information related to the inventory of products in stock and any adjustments to inventory needed because of sales, theft, spoilage, mold, or transfers to other entities.

For each 3^{rd} party ecommerce instance or retailer instance, this information is stored separately so that the platform can transfer the required information to the regulatory compliance authorities to maintain compliance with track and trace regulations.

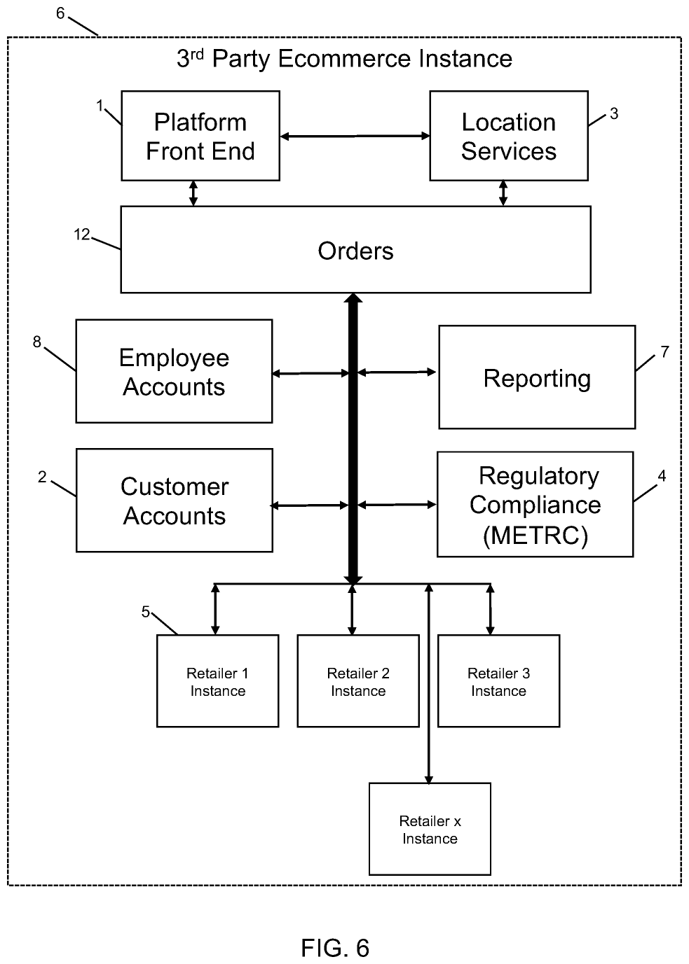

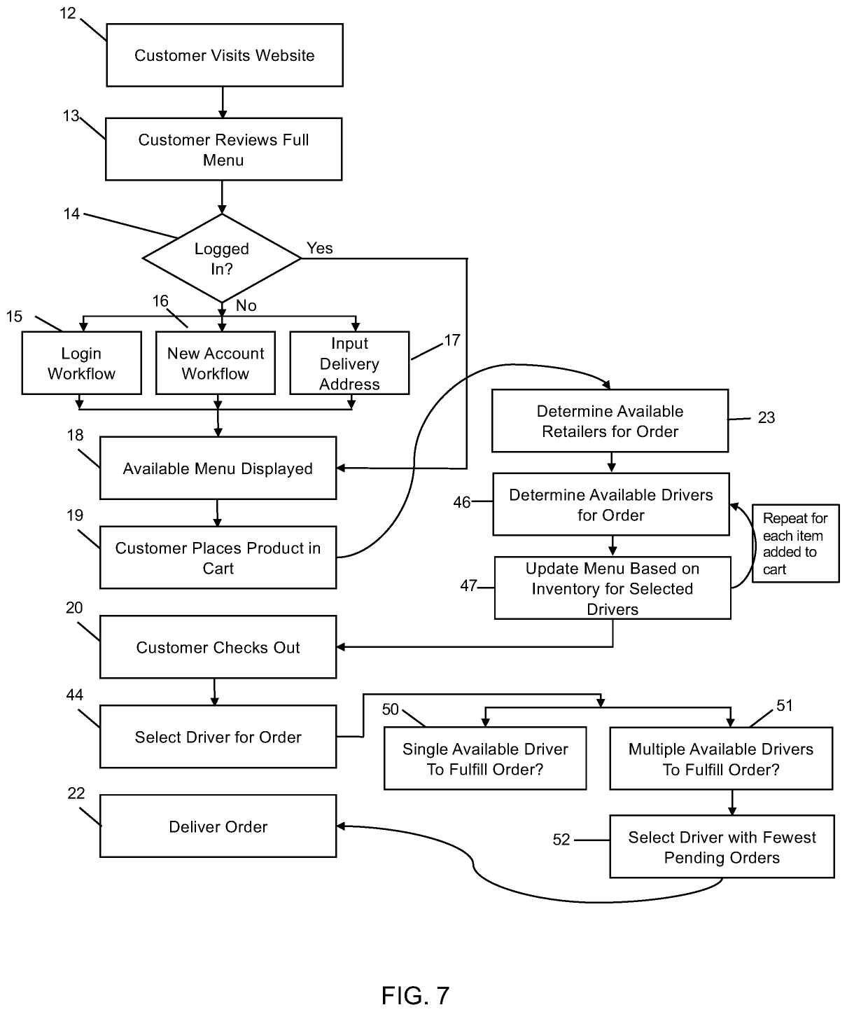

FIG. 6 is an expanded view of a 3^{rd} party ecommerce instance 6 with its functional code blocks shown. A 3rd party ecommerce instance operates by collecting a variety of cannabis products, either from a single manufacturer, or a collection of curated products assembled by a third party. This 3rd party ecommerce instance offers a menu of products (each with a SKU and unique ID tag number) for sale to a customer, but as a customer selects the products, the 3rd party ecommerce instance automatically identifies a local licensed cannabis retailer that can deliver the order to the customer at their location. This functionality is accomplished by overlaying the customer's location, as determined in location services 3, with the available Retailer Instance 5 that has the product in stock and available for delivery locally to the customer. 3^{rd} Party Ecommerce Instance 6 connects to platform front end 1 to display an online ecommerce shopping experience on a desktop browser, mobile application or mobile web browser. As the customer reviews the menu of products and places products in shopping cart 108, order block 12 starts to assemble a customer order for delivery. As this order is assembled, the platform will choose an available local retailer who has the product in stock for deliver to the customer and will update products available to the customer in the ecommerce shopping experience based on the selected retailer. The logic for this flow will be shown in detail in FIG. 7. Order block 12 is connected to Employee Accounts 8 which contains the details for the 3^{rd} party ecommerce instance employees, including names, licensing details and login information. Details such as SKUs and unique ID tag numbers are kept in sync with regulatory compliance 4 at the platform level. Similar customer data is stored in customer accounts 2 with customer details such as name, delivery address, previous orders and other relevant information. These details are kept in sync with customer accounts 2 and location services 3 at the platform level.

Reporting block 7 provides revenue, profit and customer level reporting for the 3^{rd} party ecommerce instance. Regulatory compliance block 4 communicates with regulatory compliance 4 at the platform level to store and transfer relevant transaction data (such ask product SKUs and ID tag numbers) to the state regulatory compliance authorities.

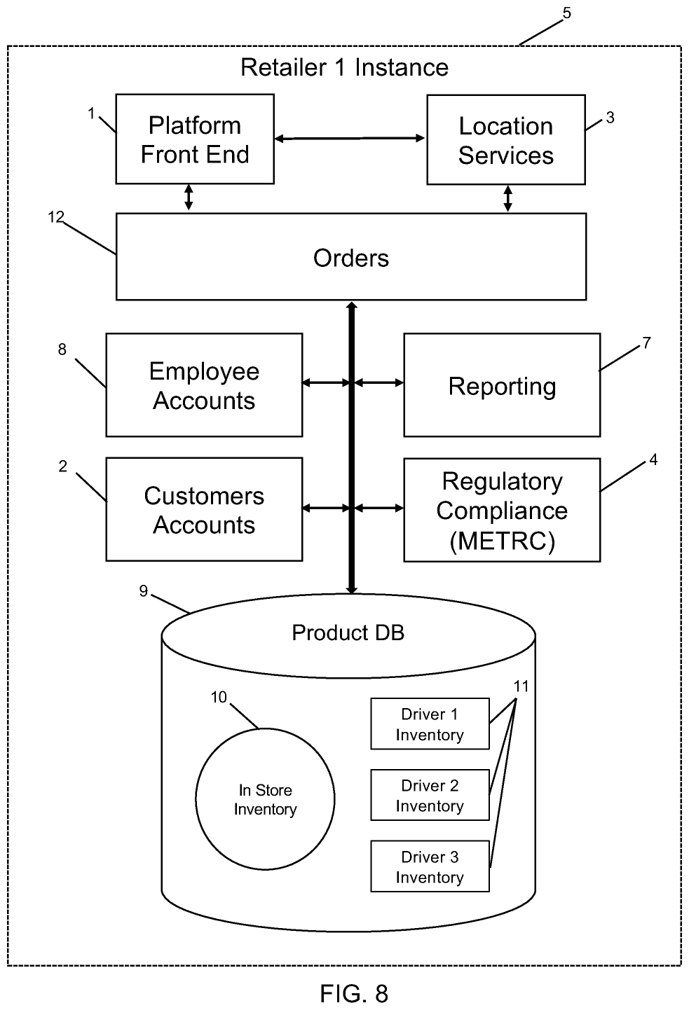

Lastly, and perhaps most importantly, 3^{rd} party ecommerce instance 6 is connected to a number of Retailer Instances 5 that can fulfil delivery orders locally for customers. These Retailer Instances 5 each have a menu of products in stock and a specific geographic delivery area. Full details of each retailer instance 5 are shown in FIG. 8. Orders 7 matches each customer with a retailer instance 5 based on the first item placed in their cart. The products available in the ecommerce store then update based on what products local retailers have in stock, then what a selected retailer and a selected driver have in stock following the logic laid out in FIGS. 8 & 11.

FIG. 8 outlines the flow of a typical customer purchase in a 3^{rd} party ecommerce instance. The purchase starts with the customer visiting the website 12 where they can see the full menu of all available products for purchase. If the user is logged in as determined by “logged in?” decision block 14, the menu of available products available for delivery to the customer's delivery address is automatically displayed based on the delivery address stored in their customer account information. If the customer is not logged in, they are given the choice of logging in with their existing credentials, creating a new account (where relevant information such as the delivery address is provided), or providing their delivery address/sharing their location. Once the available menu for delivery is displayed in 18, the customer places item in cart 19. Once that first item is placed in their shopping cart, the platform automatically determines the available retailers for the order in 22, which are the retailers that have that item in stock and can deliver it to the customer's delivery address. The platform then dynamically updates the menu based on the menu of products available from the selected retailers in 23. This means that if one or more retailers are available for a given delivery, the platform will display only the products in stock from the one or more retailers available for the particular delivery. That way, the customer only sees products that can be ordered as part of their current order and fulfilled by their selected retailers for delivery. As the customer puts items in their cart, the system determines which drivers are available for the order in 46. Available drivers have the selected product in stock in their vehicle for rapid delivery. After a driver or group of drivers is selected, the platform updates the menu based on what products are available in vehicle for the driver or group of drivers. This novel functionality ensures rapid delivery by the driver with the selected product(s) in their vehicle rather than at a physical location. As the customer adds more products to their shopping cart, this process is repeated until the customer checks out in block 20. The platform then proceeds to select the driver for the order in block 44. If there is a single driver available to fulfill the order in block 50, then that driver is given the order, if there are multiple available drivers to fulfill the order as in block 51, the retailer with the lowest number of pending orders in 52 is chosen to fulfill the order. Then deliver order in 22 is selected and the order is delivered to the customer.

FIG. 9 shows a block diagram of a retailer instance 5. A retailer instance 5 shares many common elements with a 3^{rd} party ecommerce instance 6 with the main difference being that a retailer can actually fulfill a delivery order for a customer. A retailer instance is a licensed cannabis retailer or delivery business that operates in a specific or multiple geographic regions.

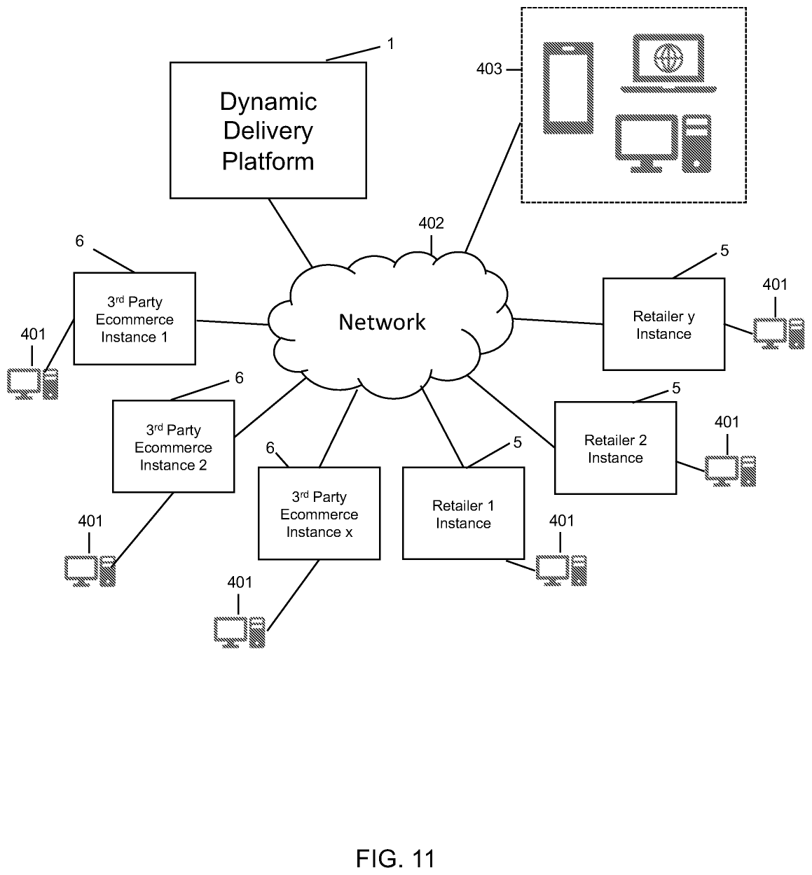

Retailer instance 5 connects to platform front end 1 to display an online ecommerce shopping experience on a desktop browser, mobile application or mobile web browser. As the customer reviews the menu of products and places products in shopping cart 108, order block 12 starts to assemble a customer order for delivery. As this order is assembled, the platform will choose an available driver who has the product in stock for delivery to the customer and will update products available to the customer in the ecommerce shopping experience based on stock on hand with the selected driver. The logic for this flow will be shown in detail in FIG. 11. Order block 12 is connected to Employee Accounts 8 which contains the details for the retailer instances employees, including names, licensing details and login information. Details such as SKUs and tag ID numbers are kept in sync with regulatory compliance 4 at the platform level. Similar customer data is stored in customer block 2 with customer details such as name, delivery address, previous orders and other relevant information.

Reporting block 7 provides revenue, profit and customer level reporting for the retailer. Regulatory compliance block 4 tracks all transaction details to send to the regulatory authorities as previously described in FIG. 5.

Product database 9 contains the menu of products offered for sale by a given retailer instance. These products are divided into In Store Inventory 10 and Driver Inventory 11. Multiple drivers can each have their own separate available driver inventory 11. This is one of the novel features of this platform. As the customer selects products, the products available for sale dynamically update based on inventory in the car of the driver selected for delivery. The user can see only other products that are also available for delivery by that given driver or set of drivers. This logic is outlined in FIG. 11.

Driver instance 57 includes pending orders 53, which tracks the pending order for the specific driver. These pending orders are used to determine which driver might receive a specific order as shown in the flow diagram of FIG. 11. Driver account 54 includes the specific credentials for the specific driver, as stored in employee accounts 28. This allows tracking of deliveries by the specific driver which is required for state regulatory compliance. Vehicle block 55 associates driver account and in-vehicle inventory with a specific delivery vehicle. Often delivery businesses have multiple delivery vehicles and this block allows tracking to the specific vehicle.

In vehicle inventory 56 stores the specific product inventory for a vehicle and driver. While it is anticipated that a driver and vehicle may start the day with a specific set of products selected for in vehicle inventory, this can be configured based on the specific cannabis retailers business needs. As a specific driver makes deliveries throughout the day, this in vehicle inventory is updated by the system in real time, so as new orders are started/placed, the real time inventory can be accessed to determine if a specific driver is available for that delivery. Additionally cash management block 57 tracks the amount of the cash a driver starts with in their cash box at the beginning of a shift and provides accounting throughout the day as a given driver accepts cash and provides change. Lastly, assigned zones 58 allows the specific driver to be assigned to a geographic area as their delivery zone. This assigned geographic area can be overlaid with the customers location to determine a set of drivers available for a given delivery. FIG. 9 shows Driver Instance 1-3 but the present invention anticipates any number of driver instances from 1 to many.

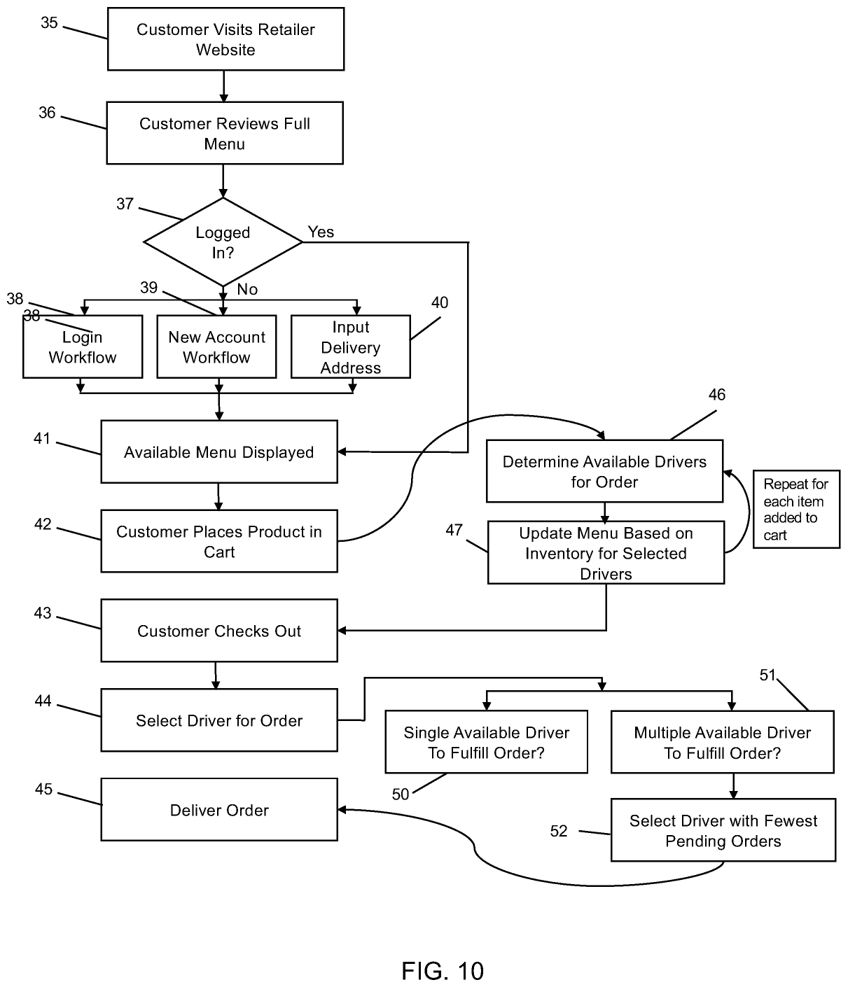

FIG. 10 outlines the flow of a typical customer purchase in a retailer instance. The purchase starts with the customer visiting the website 35 where they can see the full menu of all available products for purchase. If the user is logged in as determined by “logged in?” decision block 37, the menu of available products available for delivery to the customer's delivery address is automatically displayed based on the delivery address stored in their customer account information. If the customer is not logged in, they are given the choice of logging in with their existing credentials, creating a new account (where relevant information such as the delivery address is provided), or providing their delivery address/sharing their location. Once the available menu for delivery is displayed in 41, the customer places item in cart 42. Once that first item is placed in their shopping cart, the platform automatically determines the available drivers for the order in 46, which are the drivers that have that item in stock in their vehicle and are assigned to the delivery area for the customer. The platform then dynamically updates the menu based on the menu of products available from the selected drivers in 47. This means that if one or more retailers are available for a given delivery, the platform will display only the products in stock from the one or more retailers available for the particular delivery. That way, the customer only sees products that can be ordered as part of their current order and fulfilled by their selected driver for delivery. As the customer puts items in their cart, this process is repeated until the customer checks out in block 43. The platform then proceeds to select the driver for the order in block 44. If there is a single driver available to fulfill the order in block 50, then that retailer is given the order, if there are multiple available drivers to fulfill the order as in block 52, the driver with the lowest number of pending orders in 52 is chosen to fulfill the order. Then deliver order in 45 is selected and the order is delivered to the customer.

FIG. 11 is a view of the dynamic delivery platform at the system level. Each user device 403 includes a processor, memory, a screen, an input device, a location determination device and a connection to the network. Each of these items are well known in the art and example user devices include Apple Mac or Windows computers, Apple iPhones or Android smart phones. The smart phones include GPS location tracking and cellular/LTE/4G/5G connection to the internet, while the computers generally include IP address location data and wifi, cable modem or DSL connections to the internet. The dynamic delivery platform 1 is connected to network 402 which in the preferred embodiment is the internet.

Dynamic delivery platform 1 includes the front-end server, the database server, regulatory compliance server and location services servers. These servers are implemented using technologies well known in the art such as Amazon Cloud services and other similar services.

3^{rd} party ecommerce instances 1-x are shown in 6 and retailer instances 1-y are shown in 5 each shown with a computer 401 including point of sale (POS), product database/menu and delivery driver database functions. Computer 401 is any number of computers well known in the art such as Apple Mac and Windows PC models. 3^{rd} party ecommerce instances and retailers are connected to network 402 through means well known in the art such as wired and wireless networking, cellular, 4G/5G and LTE technologies.

Although the present invention has been described in relation to the above disclosed preferred embodiment, many modifications in design, materials and manufacturing are possible while still maintaining the novel claimed features and advantages of the invention. The preferred embodiment is not meant to limit the claims in any way, and the claims should be given the broadest possible interpretation consistent with the language of the disclosure on the whole.

1. A method for delivering cannabis products from a dynamically updating online cannabis store comprising the steps of:
providing an online store of cannabis and cannabis related products with a menu of available products for sale and delivery, the menu being comprised of products available from a plurality of cannabis retailers each with a product database, a delivery area, a physical location with an in-store inventory database of products in stock at the physical location and at least one delivery driver, each delivery driver with a delivery vehicle, a driver inventory database of products in stock in the delivery vehicle and a pending order database, the pending order database including a number of pending orders remaining to be delivered by the delivery driver, and the product database being comprised of the in-store inventory database and the driver inventory databases for the at least one delivery driver;
determining a location of a user;
calculating, based on the location of the user, a set of available cannabis retailers and a set of available delivery drivers from the set of available cannabis retailers with a the delivery area of the set available cannabis retailers overlapping the user location;
querying the product database from the set of available cannabis retailers to update the menu dynamically to display only products in the product databases from the set of available cannabis retailers;
placing, by the user one or more products for purchase selected from the menu in an online shopping cart, each product having a stock keeping unit (SKU) and an individual ID tag number provided by a state cannabis regulatory authority;
selecting one or more delivery drivers from the set of available delivery drivers who has the one or more product in the shopping cart in the driver inventory database for the delivery driver;
querying the driver inventory database for the selected one or more delivery drivers to update the menu to display only products available in the driver inventory database for the selected one or more delivery drivers;
creating an order, the order comprising the cannabis retailer, a set of products based on the one or more products placed in the shopping cart by the user, each product in the order identified by the SKU and the ID tag number for that product;
selecting a delivery driver for the order from the selected one or more delivery drivers based on the delivery driver with the lowest number of pending orders in the driver's pending order database;
updating the pending order database for the selected delivery driver with the order;
delivering by the selected delivery driver the order;
updating the product database for the cannabis retailer to remove the order from the product database;
transmitting the order to the state cannabis regulatory authority via an application programming interface (API) to update a state regulatory sales database for the cannabis retailer; and
comparing the state regulatory sales database with the product database to ensure that the product database reflects removal of the order from the product database for the cannabis retailer.

2. The method of claim 1 where the location of the user is determined by delivery address data contained in a customer accounts database.

3. The method of claim 1 where the location of the user is determined by one of the following: Global Positioning System (GPS) coordinates, Internet Protocol (IP) address or web browser location data.

4. The method of claim 1 where state cannabis regulatory authority is the state regulatory authority for the state of California.

5. The method of claim 1 where the API is connected to the state cannabis regulatory authority for the state of California.

6. The method of claim 1 where the cannabis retailer is licensed to sell cannabis products by a state, Federal or national authority.

7. The method of claim 1 where the cannabis retailer is licensed to sell cannabis products by the state of California.

8. A method for delivering cannabis products from a dynamically updating online cannabis store comprising the steps of:
providing an online store of cannabis and cannabis related products with a menu of available products for sale and delivery, the online store being associated with a cannabis retailer having a product database, a physical location with an in-store inventory database of products in stock at the physical location and at least one delivery driver, each delivery driver with a delivery vehicle, a delivery area, a driver inventory database of products in stock in the delivery vehicle and a pending order database, the pending order database including a number of pending orders remaining to be delivered by the delivery driver, the product database being comprised of the in-store inventory database and the driver inventory databases for the at least one delivery driver, and the menu comprising the product database for the cannabis retailer;
determining a location of a user;
calculating, based on the location of the user, a set of available delivery drivers with the delivery area of the set of available delivery drivers overlapping the user location;
placing, by the user one or more products for purchase selected from the menu in an online shopping cart, each product having a stock keeping unit (SKU) and an individual ID tag number provided by a state cannabis regulatory authority;
selecting a delivery driver from the set of available delivery drivers who has the one or more product in the shopping cart in the driver inventory database for the delivery driver;
querying the driver inventory database for the selected delivery driver to update updating the menu to display only the products available in the driver inventory database for the selected delivery driver;
creating an order, the order comprising a set of products based on the one or more products placed in the shopping cart by the user, each product in the order identified by the SKU and the ID tag number for that product;
updating the pending order database for the selected delivery driver with the order;
delivering by the selected delivery driver the order;
updating the product database for the cannabis retailer to remove the order from the product database;
transmitting the order the to the state cannabis regulatory authority via an application programming interface (API) to update a state regulatory authority sales database for the cannabis retailer; and
comparing the state regulatory sales database with the product database to ensure that the product database reflects removal of the order from the product database for the cannabis retailer.

9. The method of claim 8 where the location of the user is determined by delivery address data contained in a customer accounts database.

10. The method of claim 8 where the location of the user is determined by one of the following: Global Positioning System (GPS) coordinates, Internet Protocol (IP) address or web browser location data.

11. The method of claim 8 where state regulatory authority is the state cannabis regulatory authority for the state of California.

12. The method of claim 1 where the API is connected to the state cannabis regulatory authority for the state of California. METRC.

13. The method of claim 8 where the cannabis retailer is licensed to sell cannabis products by a state, Federal or national authority.

14. The method of claim 8 where the cannabis retailer is licensed to sell cannabis products by the state of California.

15. A system for providing a dynamically updating online cannabis store, the system comprising:
one or more computer systems, each of the computer systems related to a cannabis retailer with a delivery area and a physical location, the computer system including a point-of-sale (POS) system for processing orders of cannabis products, a product database with a menu of available products for sale and delivery, an in-store inventory database of products in stock at the physical location and a delivery driver database, the delivery driver database comprising a database of one or more delivery drivers, each delivery driver with a delivery vehicle, a driver inventory database of products in stock in the delivery vehicle and a pending order database, the pending order database comprising a number of pending orders remaining to be delivered by the delivery driver;
a front-end server for displaying an online store of cannabis and cannabis related products including a rendering engine for displaying a menu of available cannabis products, the menu comprising one or more cannabis retailer product databases, an online shopping cart and a transaction processor;
a database server including a database of customer account information, a regulatory compliance server including a sales database, and a connection via an application program interface (API) to a central repository maintained by a state cannabis regulatory compliance authority;
a location services server for determining a location of a user; and
a user device including a processor and memory for executing applications, a screen, an input device, a location determination means for determining the user location and a communications means to connect to a network; wherein the location services server determines the location for the user based on customer account information or location information provided by the user device;
the front-end server calculates, based on the location of the user, a set of available cannabis retailers and a set of available delivery drivers from the set of available cannabis retailers with a the delivery area of the set of available cannabis retailers overlapping the user location;
the front-end server updates the online store to display the menus comprising the product databases from the set of available cannabis retailers;
the user utilizes the user device to place one or more items for purchase from the menu in the online shopping cart, each item having a stock keeping unit (SKU) and an individual ID tag number provided by the state cannabis regulatory authority;
the front-end server selects one or more delivery drivers from the set of available delivery drivers who has the one or more items in the shopping cart in the driver inventory database for the delivery driver;
the front-end server queries the driver inventory database for the selected one or more delivery drivers to updates the menu to display the driver inventory database for the selected one or more delivery drivers;
the transaction processor creates an order, comprising the cannabis retailer, a set of products based on the one or more items placed in the shopping cart by the user, each item in the order identified by the SKU and the ID tag number for that item;
the transaction processor selects a delivery driver for the order from the selected one or more delivery drivers based on the delivery driver with the lowest number of pending orders in the delivery driver pending order database;
the selected delivery driver delivers the order; the transaction processor updates the product database for the cannabis retailer to remove the order from the product database;
the regulatory compliance server updates the sales database and transmits the updated sales database for the cannabis retailer to the state cannabis regulatory authority via the API to update a state regulatory authority sales database for the cannabis retailer; and
the regulatory compliance server compares the state regulatory authority sales database with the product database to ensure that the product database for the cannabis retailer reflects removal of the order from the product database for the cannabis retailer.

16. The system of claim 15 where the location of the user is determined by delivery address data contained in the database of customer accounts information.

17. The system of claim 15 where the location of the user is determined by one of the following: Global Positioning System (GPS) coordinates, Internet Protocol (IP) address or web browser location data.

18. The method of claim 15 where state regulatory authority is the state cannabis regulatory authority for the state of California.

19. The method of claim 15 where the API is connected to the state cannabis regulatory authority for the state of California.

20. The system of claim 15 where the cannabis retailer is licensed to sell cannabis products by a state, Federal or national authority.

21. The system of claim 15 where the cannabis retailer is licensed to sell cannabis products by the state of California.

22. A system for providing a dynamically updating online cannabis store, the system comprising:
a computer system, related to a cannabis retailer with a delivery area and a physical location, the computer system including a point-of-sale (POS) system for processing orders of cannabis products, a product database with a menu of available products for sale and delivery, an in-store inventory database of products in stock at the physical location and a delivery driver database, the delivery driver database comprising a database of one or more delivery drivers, each delivery driver with a delivery vehicle, a driver inventory database of products in stock in the delivery vehicle and a pending order database, the pending order database comprising a number of pending orders remaining to be delivered by the delivery driver;
a front-end server for displaying an online store of cannabis and cannabis related products including a rendering engine for displaying a menu of available cannabis products, the menu comprising the product database, an online shopping cart and a transaction processor;
a database server including a database of customer account information, a regulatory compliance server including a sales database and a connection via an application program interface (API) to a central repository maintained by a state cannabis regulatory compliance authority;
a location services server for determining a location of a user; and
a user device including a processor and memory for executing applications, a screen, an input device, a location determination means for determining the user location and a communications means to connect to a network; wherein the location services server determines the location for the user based on customer account information or location information provided by the user device;
the front-end server calculates, based on the location of the user, a set of available delivery drivers with the delivery area of the available delivery drivers overlapping the user location;
the user utilizes the user device to place one or more products from the menu for purchase in the online shopping cart, each product having a stock keeping unit (SKU) and an individual ID tag number provided by a the state cannabis regulatory authority;
the front-end server selects a delivery driver from the set of available delivery drivers who has the one or more product in the shopping cart in the driver inventory database for the delivery driver;
the front-end server queries the driver inventory database for the selected delivery driver to updates the menu to display the driver inventory database for the selected driver;
the transaction processor creates an order, comprising a set of products based on the one or more products placed in the shopping cart by the user, each item in the order identified by the SKU and the ID tag number for that item;
The selected delivery driver delivers the order;
the transaction processor updates the product database for the cannabis retailer to remove the order from the product database;
the regulatory compliance server updates the sales database and transmits the updated sales database for the cannabis retailer to the state cannabis regulatory authority via the API to update a state regulatory authority sales database for the cannabis retailer; and
the regulatory compliance server compares the state regulatory authority sales database with the product database to ensure that the product database for the cannabis retailer reflects removal of the order from the product database for the cannabis retailer.

23. The system of claim 22 where the location of the user is determined by delivery address data contained in the database of customer accounts information.

24. The system of claim 22 where the location of the user is determined by one of the following: Global Positioning System (GPS) coordinates, Internet Protocol (IP) address or web browser location data.

25. The method of claim 22 where state regulatory authority is the state cannabis regulatory authority for the state of California.

26. The method of claim 22 where the API is connected to the state cannabis regulatory authority for the state of California.

27. The system of claim 22 where the cannabis retailer is licensed to sell cannabis products by a state, Federal or national authority.

28. The system of claim 22 where the cannabis retailer is licensed to sell cannabis products by the state of California.
